(19) United States
(12) Patent Application Publication
(10) Pub. No.: US 2021/0192609 A1
(43) Pub. Date: Jun. 24, 2021

(54) ARTIFICIAL INTELLIGENCE-BASED SYSTEMS FOR MANAGING BIG DATA FOR ABANDONED PROPERTY COMPLIANCE

(71) Applicant: BANK OF AMERICA CORPORATION, Charlotte, NC (US)

(72) Inventors: Ashley Anne Walsh, Charlotte, NC (US); John Michael Henggeler, Coeur d'Alene, ID (US); Dean Alan Iley, Chesapeake, VA (US); Ashok Kumar, Houston, TX (US)

(73) Assignee: BANK OF AMERICA CORPORATION, Charlotte, NC (US)

(21) Appl. No.: 16/723,134

(22) Filed: Dec. 20, 2019

(51) Int. Cl. G06Q 40/02; G06Q 20/10; G06N 20/00

(52) U.S. Cl. CPC G06Q 40/02; G06Q 50/186; G06N 20/00; G06Q 20/108

(57) ABSTRACT

A system that provides for identifying eligible account activity including a related date of last account activity for purposes of managing escheatment. Specifically, the present invention provides for implementing artificial intelligence including machine learning techniques to definitively identify, which electronic transactions are recurring transactions and, once transactions have been identified as one-time-only or recurring, state-specific abandoned property requirements are applied to determine a date of last activity for a financial account. The date of last activity, along with other dates of interest, are subsequently monitored to determine when property remaining in an inactive financial account escheats to the state.

### FIELD OF THE INVENTION

The present invention is generally related to data processing and, more specifically applying artificial intelligence, including machine learning techniques, to big data to assist in complying with location-specific (e.g., state-specific) abandoned property (i.e., escheatment) compliance requirements.

### BACKGROUND

Financial institutions are mandated by state-level government agencies to maintain an escheatment process. Escheatment is the reversion to the state of property remaining in financial accounts, based on the financial accounts having not incurred any customer contact or activity within a specified period of time. However, different states have different requirements as to what constitutes an “activity” for purposes of updating the date of last activity associated with an account. In this regard, some states allow for recurring electronic transactions to update an account's date of last activity while other states forbid such transactions from updating the date of last activity.

While customers and merchants may identify some transactions as recurring transactions, heretofore, financial institutions have had no process for determining which transactions are, in fact, recurring transactions for escheatment purposes. In this regard, while procedures may exist for determining which transactions may be recurring, such a level of accuracy is inadequate when the result of the determination is relied upon for determining whether property should escheat to the state.

Therefore, a need exists to develop systems, methods, computer program products and the like which provide for identification of eligible account activity including a related date of last activity for purposes of managing escheatment. The desired automated systems and the like should prevent and, in some instances, eliminate, the occurrence of errors (i.e., escheating property that should not be escheated and failing to escheat property that rightfully should be escheated). In this regard, the desired systems and the like should be able to identify and differentiate which electronic transactions are recurring transactions and subsequently apply state-specific abandoned property requirements to determine which transaction qualify to update the date of last activity.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a highly accurate means of identifying eligible account activity for purposes of determining account abandonment. Specifically, the present invention provides for implementing artificial intelligence, including machine learning techniques, to identify, which electronic transactions are recurring transactions versus one-time only or first-time transactions and subsequently apply state-specific abandoned property compliance requirements to determine an account's date of last activity. In specific embodiments of the invention, an account's date of last activity and, in some embodiments of the invention, additional escheatment factors related to the account (e.g., an account's date of last customer contact) are monitored to aid in the determination of when an inactive financial account escheats to the state.

Specifically, the present invention implements artificial intelligence and specifically machine learning to recognize, over time, patterns in historical transaction data and analyze the patterns to determine if a transaction is a recurring transaction. The result is a process that minimizes, and in some instances, eliminates the occurrence of false negatives, which thereby lessens the likelihood that errors in escheatment occur.

A system for evaluating transaction data to determine activity that is eligible to update a date of last activity associated with a financial account defines first embodiments of the invention. The system includes one or more financial transaction databases that store historical transaction data for financial accounts. The system further includes a first computing platform including a first memory and at least one first processor in communication with the first memory. The first memory stores first instructions that are executable by the first processor and configured to receive data associated with one or more electronic financial transactions associated with a financial account occurring over a predetermined period of time and access the one or more financial transaction databases to retrieve the historical transaction data for the financial account. The instructions are further configured to implement artificial intelligence, including machine learning techniques, to (i) identify recurring transaction patterns in the historical transaction data for the financial accounts, and (ii) analyze the recurring transaction patterns and the data to identify each of the one or more electronic financial transactions as either a one-time-only transaction or a recurring transaction. Moreover, the instructions are configured to apply abandoned property (i.e., escheatment) compliance requirements, which are specific to a jurisdictional entity (e.g., a U.S. state or the like) at which the account holder is located, to update a date of last activity associated with the financial account based at least in part on the identification of each of one or more electronic financial transactions as either a one-time-only transaction or a recurring transaction.

In specific embodiments of the system, the first instructions are further configured to provide for an abandoned property compliance portal/hub that is configured to generate and display, in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction. In related embodiments of the system, the abandoned property compliance portal/hub is further configured to generate and display, in response to receiving a user input that identifies the financial account and a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

In further specific embodiments the system further comprises a second computing platform including a second memory and at least one second processor in communication with the second memory. The second memory stores second instructions that are executable by the second processor and configured to determine that a time period between the date of last activity and a current date exceeds an abandoned property time period defined in the abandoned property compliance requirements, and, in response to determining that the time period exceeds the abandoned property time period, escheat property in the financial account to a third-party agency associated with a jurisdiction of the financial account.

In still further specific embodiments of the system, the first instructions are further configured to receive indication of a scheduled transaction from a customer-configured recurring transaction schedule, in response to determining that that the scheduled transaction is a first-time occurrence of the scheduled transaction, identify the scheduled transaction as a first-time transaction, and, in response to determining that that the scheduled transaction is not a first-time occurrence of a scheduled transaction from the customer-configured recurring transaction schedule, identify the scheduled transaction as a recurring transaction. In related embodiments of the system, the first instructions are further configured to apply the abandoned property compliance requirements to update the date of last activity associated with the financial account is based on identification of at least one of (i) each of the one or more electronic financial transactions as either a one-time-only transaction or a recurring transaction, and (ii) the scheduled transaction as the first-time transaction or a recurring transaction.

In additional specific embodiments of the system, the instructions configured to analyze the recurring transaction patterns are further configured to identify a transaction as recurring based on one or more of (i) the transaction using a same financial account as one of the recurring transaction patterns, (ii) the transaction being assigned a same transaction code as one of the recurring transaction patterns, (iii) the transaction being same transacting-party as one of the recurring transaction patterns, (iv) the transaction occurring within a predefined period of time from a last occurrence of another transaction within one of the recurring transaction patterns, and (iv) the transaction being within a predefined variance of a transaction amount of other transactions within one of the recurring transaction patterns. In related embodiments of the system, the instructions configured to identify the transaction as recurring based on (iv) the transaction occurring within a predefined period of time from a last occurrence of another transaction within one of the recurring transaction patterns, and (iv) the transaction being within a predefined variance of a transaction amount of other transactions within one of the recurring transaction patterns, define at least one of the predefined period of time and the predefined variance based on a time cycle of the recurring transaction patterns.

Moreover, in additional embodiments of the system, the instructions configured to receive the data associated with one or more electronic financial transactions are further configured to receive data associated with the one or more electronic financial transactions, wherein the electronic financial transactions are defined as at least one of (i) Automated Clearing House (ACH) transactions, and (ii) wire transactions, (iii) electronic bill pay, (iv) automatic transfers, and (v) recurring merchant payments.

Further, in additional specific embodiments of the system, the abandoned property compliance requirements are configured for either (i) a most recent occurrence of a one-time-only transaction, or (ii) a most recent occurrence of a recurring transaction, defining the date-of-last-activity associated with the financial account. In related embodiments of the system, the abandoned property compliance requirements are further configured for a type of a recurring transaction to define the date of last activity associated with the financial account.

A computer-implemented method for evaluating transaction data to determine activity that is eligible to update a date of last activity associated with a financial account defines second embodiments of the invention. The method is executed by one or more computing processor devices and includes receiving data associated with one or more electronic financial transactions associated with a financial account occurring over a predetermined period of time and receiving historical transaction data related to the financial account. The method further includes implementing artificial intelligence including machine learning techniques for (i) identifying recurring transaction patterns in the historical transaction data for the financial accounts, and (ii) analyzing the recurring transaction patterns and data to identify each of the one or more electronic financial transactions as either a one-time-only transaction or a recurring transaction. The method further includes applying abandoned property (i.e., escheatment) compliance requirements, which are specific to a jurisdictional entity (e.g., a U.S. state or the like) at which the account holder is located, to update a date of last activity associated with the financial account based at least in part on the identification of each of one or more electronic financial transactions as either a one-time-only transaction or a recurring transaction.

In specific embodiments the computer-implemented method further includes generating and displaying, within an abandoned property portal/hub, (1) in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction, and (2) in response to receiving a user input that identifies the financial account a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

In further specific embodiments the computer-implemented method includes determining that a time period between the date of last activity and a current date exceeds an abandoned property time period defined in the abandoned property compliance requirements and, in response to determining that the time period exceeds the abandoned property time period, escheat property in the financial account to a third-party agency associated with a jurisdiction of the financial account.

In additional specific embodiments the computer-implemented method further includes receiving indication of a scheduled transaction from a customer-configured recurring transaction schedule, in response to determining that that the scheduled transaction is a first-time occurrence of the scheduled transaction, identifying the scheduled transaction as a first-time transaction and in response to determining that that the scheduled transaction is not a first-time occurrence of a scheduled transaction from the customer-configured recurring transaction schedule, identifying the scheduled transaction as a recurring transaction. In such embodiments of the computer-implemented method applying the abandoned property compliance requirements further includes applying the abandoned property compliance requirements to update the date of last activity associated with the financial account is based on identification of at least one of (i) each of the one or more electronic financial transactions as either a one-time-only transaction or a recurring transaction, and (ii) the scheduled transaction as the first-time transaction or a recurring transaction.

Moreover, in additional specific embodiments of the computer-implemented method analyzing the recurring transaction patterns further includes analyzing the recurring transaction patterns to identify each of the one or more electronic financial transactions as the recurring transaction based on one or more of (i) the transaction using a same financial account as one of the recurring transaction patterns, (ii) the transaction being assigned a same transaction code as one of the recurring transaction patterns, (iii) the transaction being same transacting-party as one of the recurring transaction patterns, (iv) the transaction occurring within a predefined period of time from a last occurrence of another transaction within one of the recurring transaction patterns, and (iv) the transaction being within a predefined variance of a transaction amount of other transactions within one of the recurring transaction patterns.

A computer program product including a non-transitory computer-readable medium defines third embodiments of the invention. The computer-readable medium includes a first set of codes for causing a computer to receive data associated with one or more electronic financial transactions associated with a financial account occurring over a predetermined period of time. Additionally, the computer-readable medium includes a second set of codes for causing a computer to receive historical transaction data related to the financial account. In addition, the computer-readable medium includes a third set of codes for causing a computer to implement artificial intelligence including machine learning techniques to (i) identify recurring transaction patterns in the historical transaction data for the financial accounts, and (ii) analyze the recurring transaction patterns and data to identify each of the one or more electronic financial transactions as either a one-time-only transaction or a recurring transaction. In addition, the computer-readable medium includes fourth instructions for causing a computer to apply abandoned property (i.e., escheatment) compliance requirements, which are specific to a jurisdictional entity (e.g., a U.S. state or the like) at which the account holder is located, to update a date of last activity associated with the financial account based at least in part on the identification of each of one or more electronic financial transactions as either a one-time-only transaction or a recurring transaction.

In additional specific embodiments of the computer program product, the computer-readable medium further includes a fifth set of codes for causing a computer to generate and display, within an abandoned property portal/hub, (1) in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction, and (2) in response to receiving a user input that identifies the financial account a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

In further specific embodiments of the computer program product, the computer-readable medium further includes a fifth set of codes for causing a computer to determine that a time period between the date of last activity and a current date exceeds an abandoned property time period defined in the abandoned property compliance requirements, and, in response to determining that the time period exceeds the abandoned property time period, escheat property in the financial account to a third-party agency associated with a jurisdiction of the financial account.

In additional specific embodiments of the computer program product, the computer-readable medium further includes a fifth set of codes for causing a computer to receive indication of a scheduled transaction from a customer-configured recurring transaction schedule, in response to determining that that the scheduled transaction is a first-time occurrence of the scheduled transaction, identifying the scheduled transaction as a first-time transaction, and, in response to determining that that the scheduled transaction is not a first-time occurrence of a scheduled transaction from the customer-configured recurring transaction schedule, identifying the scheduled transaction as a recurring transaction. In such embodiments of the computer program product, the fourth set of codes is further configured to cause the computer to apply the abandoned property compliance requirements to update the date of last activity associated with the financial account is based on the identification of at least one of (i) each of the one or more electronic financial transactions as either a one-time-only transaction or a recurring transaction, and (ii) the scheduled transaction as the first-time transaction or a recurring transaction.

Thus, according to embodiments of the invention, which will be discussed in greater detail below, the present invention provides for identifying eligible account activity for purposes of escheatment. Specifically, the present invention provides for implementing artificial intelligence, including machine learning techniques, to definitively identify, which electronic transactions are recurring transactions and subsequently apply state-specific abandoned property requirements to determine a date of last activity for a financial account. In specific embodiments of the invention, the date of last activity, along with other relevant account-related factors/dates, are monitored to determine when property remaining in an inactive financial account escheats to the state.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for evaluating transaction data to determine activity that is eligible to update a date of last activity associated with a financial account, in accordance with embodiments of the present invention;

FIG. 2 is a schematic diagram of an alternative system for evaluating transaction data to determine activity that is eligible to update a date of last activity associated with a financial account, in accordance with some embodiments of the present disclosure;

FIG. 3 is a schematic diagram highlighting two different views provided by an abandoned property portal/hub/hub, in accordance with embodiments of the present invention;

FIG. 4 is a block diagram of a computing platform configured for evaluating transaction data to determine activity that is eligible to update a date of last activity associated with a financial account, in accordance with some embodiments of the present disclosure;

FIG. 5 is a flow diagram of a method for evaluating transaction data to determine activity that is eligible to update a date of last activity associated with a financial account, in accordance with embodiment of the present invention;

FIG. 6 is a flow diagram of an alternative method for evaluating transaction data to determine activity that is eligible to update a date of last activity associated with a financial account, in accordance with embodiments of the present invention; and

FIG. 7 is flow diagram of a method for evaluating transaction data to determine activity that is eligible to update a date of last activity associated with a financial account, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that provide for an accurately evaluating transaction data to determine activity that is eligible to update a date of last activity associated with a financial account for purposes of managing abandoned property, otherwise referred to herein as escheatment. Specifically, the present invention provides for implementing artificial intelligence including machine learning techniques to definitively identify, which electronic transactions are recurring transactions and subsequently apply state-specific abandoned property requirements to determine a date of last activity for a financial account.

In specific embodiments of the invention, an account's date of last activity is monitored, along with other relevant account-related dates (e.g., date of last contact or the like), to determine when property remaining in an inactive financial account escheats to the state. As previously stated, some states allow electronic recurring transactions to qualify to update an account's date of last activity for purposes of determining when escheatment occurs, while other states forbid such transactions from qualifying as a date of least activity. The present invention provides automated and certain means of categorizing electronic transactions, such as Automated Clearinghouse House (ACH), wire transactions, bill pay transactions, automatic transfers, and recurring merchant payments as either recurring or one-time-only (i.e., non-recurring) and, once categorized, applying the state-specific requirements to determine a date of last activity and, based on the date of last activity, when escheatment occurs.

Specifically, the present invention implements artificial intelligence and, specifically, machine learning to recognize, over time, recurring patterns in historical transaction data and analyze the patterns to determine if a transaction is a recurring transaction. The result is a process that minimizes, and in some instances, eliminates the occurrence of false negatives in the determining of recurring transactions, which, in turn, ensures that errors in escheatment do not occur.

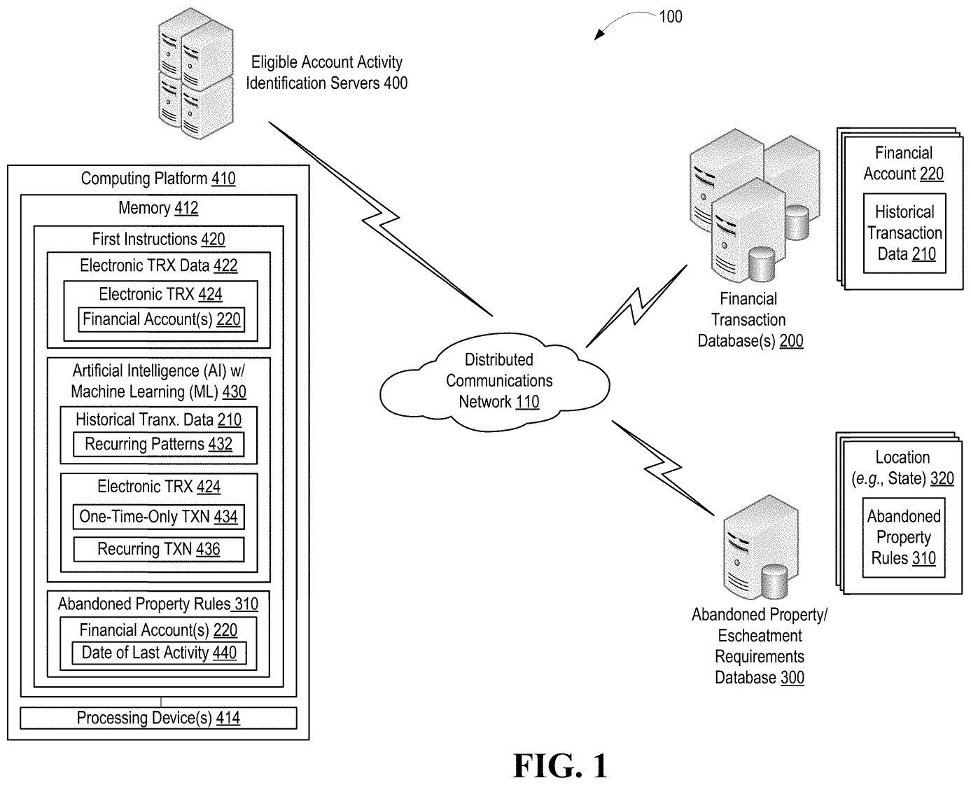

Referring to FIG. 1, a schematic diagram is depicted of a system 100 for evaluating transaction data to determine activity that is eligible to update a date of last activity associated with a financial account, in accordance with embodiments of the present invention. The system 100 is implemented in a distributed communications network 110, which may include one or more intranets and/or the Internet or the like. The system 100 includes one or more financial transaction database(s) 200 that are configured to store historical transaction data 210 for a plurality of financial accounts.

The system 100 additionally includes abandoned property compliance requirements database 300 that is configured to store abandoned property compliance requirements 310 for a plurality of different jurisdictions 320 (e.g., U.S. states or the like having specific abandoned property requirements). As previously discussed, the abandoned property compliance requirements 310 will define the criteria for assigning a date of last activity to a financial account. In this regard, the requirements 310 for a specific location/state may define whether an electronic recurring transaction (and in some instances, which type(s) of electronic recurring transactions) may serve as the date of last activity. In addition, the requirements 310 define the time period of inactivity required for escheatment to occur, which may vary from state-to-state.

The system 100 additionally includes one or more eligible account activity identification server(s) 400 that are in network communication with the financial transaction database(s) 200 and the abandoned property compliance requirements database 300 via distributed communications network 110. The eligible account activity identification server(s) 400 include a computing platform 410 having a memory 412 and one or more processing devices 414 in communication with the memory 410. The memory 412 stores first instructions 420 that are executable by the one or more processing devices 414. The first instructions 420 are configured to receive electronic transaction data 422 associated with electronic transactions 424 from at least one of the plurality financial accounts 220. In specific embodiments of the invention, the electronic transaction data 422 is associated with most, if not all, of the plurality of financial accounts 220 within a financial institution, as such, for large financial institutions, so called “big data” processing is subsequently implemented to determine transaction patterns and identify transactions as recurring, one-time-only and, in specific embodiments of the invention, first time occurrence of a scheduled transaction. In specific embodiments of the invention the received electronic transaction data 422 reflects all of the electronic transactions that have occurred over a predetermined period of time (e.g., a week, a day or the like). In such instances, the subsequent process of determining a date of last activity for the financial account(s) 220 occurs on the same cycle (e.g., weekly, daily or the like). It should also be noted that financial transactions are typically coded to indicate the type of transaction and, as such, in specific embodiments of the invention, the first instructions 420 may be configured to only receive financial transaction data that is coded to indicate specific types of transactions, such as, electronic transactions, e.g., ACH transactions, wire transactions, bill pay transactions, automatic transfers, recurring merchant payments or the like. In addition to receiving the electronic transaction data 422, the first instructions 420 are configured to access the financial transaction database 200 to retrieve historical transaction data 210 associated with the at least one of the plurality of financial accounts 220.

The first instructions 420 are further configured to implement artificial intelligence including machine learning 430 to identify recurring transaction patterns 432 in the historical transaction data 210. It should be noted that machine learning techniques provide for the identification of recurring transaction patterns 432 to occur over time. As such, the recurring transaction patterns 432 may be identified during modeling/training modes of operation and/or during the current cycle and/or previous cycles of the identification of eligible account activity process. In addition, the first instructions 420 are configured to implement artificial intelligence to analyze the recurring transaction patterns 432 and the electronic transaction data 422 to identify each of the electronic transactions 424 as either a one-time-only transaction 434 (i.e., non-recurring) or a recurring transaction 436 (i.e., a repetitive transaction between the same parties that occurs on a regular cycle (e.g., annually, bi-annually, monthly, bi-monthly, weekly, daily or the like)). As previously discussed, the identification of recurring transaction patterns 432 and the identification of electronic transactions 424 as being either a one-time-only transaction 434 or recurring transaction 436 is conducted with a high degree of certainty, so as to limit, and in some instances, prohibit the occurrences of false negatives.

The first instructions 420 are further configured to access the abandoned property compliance requirements database 300 to retrieve the location/state-specific abandoned property compliance requirements 310 associated with the location/state of the financial accounts(s) 220. Further, the first instructions 420 are configured to apply the abandoned property compliance requirements 310 to update a date of last activity 440 associated with each of the financial account(s) 220. As previously discussed, the abandoned property compliance requirements 310 indicate whether a specific location/state allows for recurring electronic transactions and, in some instances, which type of recurring electronic transactions, to qualify for purposes of a date of last activity. The update to the date of last activity 440 is based, at least in part, on the identification of each of the electronic transactions 424 as being either a one-time-only transaction 434 or a recurring transaction 436. It should be appreciated that transactions other than electronic transactions may factor into the update of the date of last activity and, as a result, the update to the date of last of activity may not reflect a date corresponding to the most recent one-time-only electronic transaction or the most recent occurring recurring electronic transaction, if the date of one of the other transactions (i.e., a non-electronic transaction or the like) is determined to be later in time.

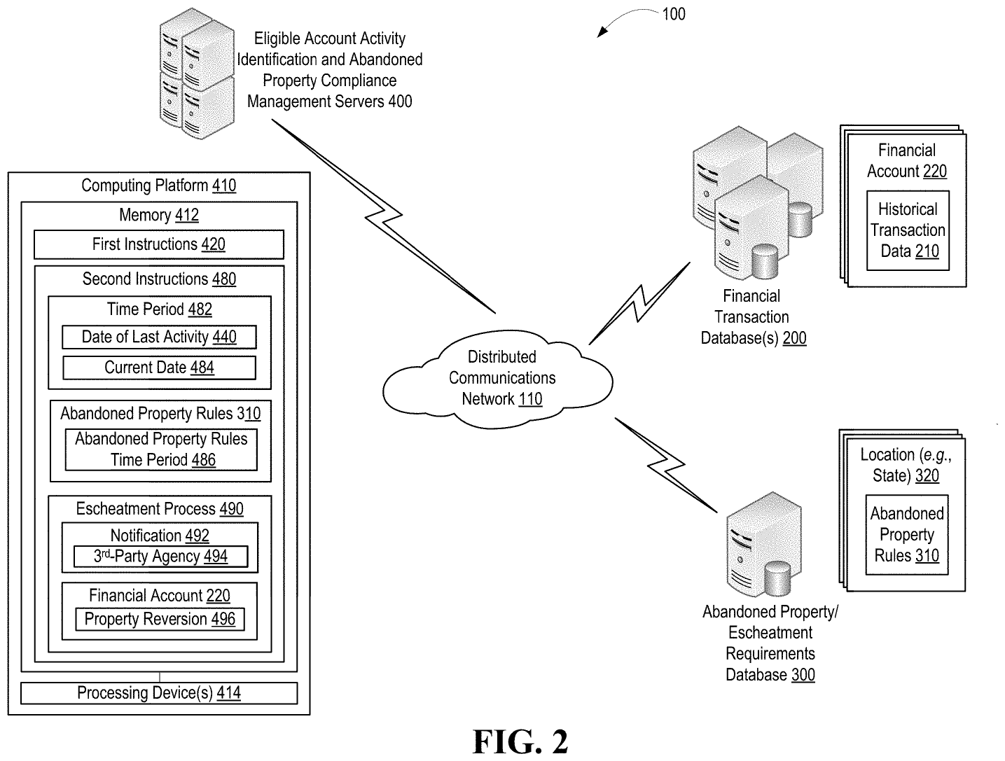

Referring to FIG. 2, a schematic diagram is provided of the system 100 for evaluating transaction data to determine activity that is eligible to update a date of last activity associated with a financial account, in accordance with alternative embodiments of the invention. In the embodiments described in relation to FIG. 2, the memory 412 of computing platform 410 additionally stores second instructions 480 that are configured to monitor the date of last activity 440 along with other relevant account-related dates/factors to determine when escheatment occurs (i.e., when property in a financial reverts to the state due to inactivity for a prescribed period of time). Other relevant account-related factors take into account that certain states or other jurisdictional locations may look to a date other than the date of last activity 440 for purposes of triggering escheatment. For example, in addition to account activity/transactions, certain states may look to account contacts (e.g., checking online balances, calling the financial institution regarding an account and the like) for purposes of updating an applicable date (i.e., a date of last contact). In this regard, monitoring entails determining when a time period 482 between the date of last activity or contact 440 and a current date 484 exceeds an abandoned property time period 486 as defined by the location/state-specific abandoned property compliance requirements 310. For example, if the abandoned property compliance requirements 310 define the escheatment property time period as five years and the time period between the current date and the date of last activity or contact is determined to be greater than five years then, the escheatment process 490 ensues. The instructions 480 are further configured to implement the escheatment process 490 in response to determining that the time period 482 between the date of last activity or contact 440 and the current date 484 exceeds the abandoned property requirements time period 486. The escheatment process may include, but is not limited to, generating and initiating electronic communication of a notification 492 to a third-party agency 494 (e.g., state or other government agency) that notifies the third-party agency of the escheatment and that property related to the escheatment is forthcoming. In other embodiments of the invention, the escheatment process 490 includes automatic property reversion/escheatment 496 of the property held in the financial account 220 in response to the determination that the time period 482 between the date of last activity or contact 440 and the current date 484 exceeds the abandoned property requirements time period 486.

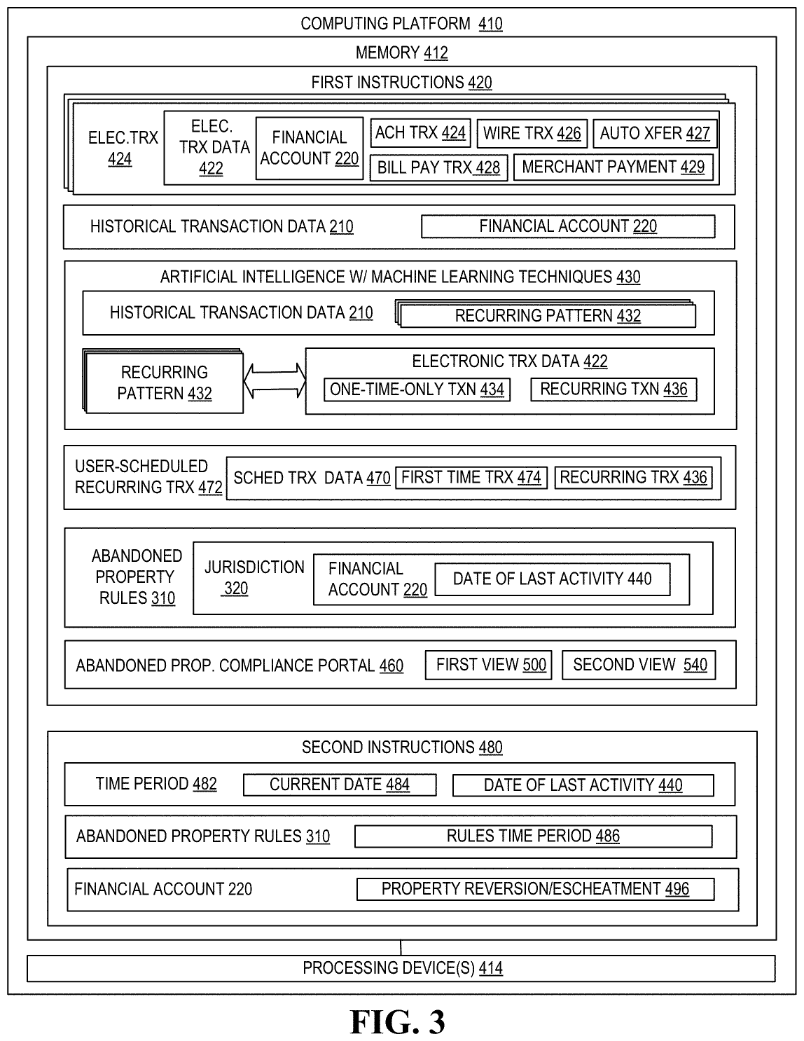

FIG. 3 depicts a block diagram of the computing platform 410 for evaluating transaction data to determine activity that is eligible to update a date of last activity associated with a financial account, in accordance with various embodiments of the present invention. The computing platform 410 may comprise one or typically more computing devices (e.g., servers or the like) and is configured to execute instructions, such as algorithms, modules, routines, applications and the like. Computing platform 410 includes memory 412 and the like which may comprise volatile and non-volatile memory, such as read-only and/or random-access memory (RAM and ROM), EPROM, EEPROM, flash cards, or any memory common to computing platforms). Moreover, memory 412 and the like may comprise cloud storage, such as provided by a cloud storage service and/or a cloud connection service.

Further, computing platform 410 also includes at least one processing device 414, or the like which may be an application-specific integrated circuit (“ASIC”), or other chipset, logic circuit, or other data processing device configured to implement artificial intelligence including machine learning techniques. Processing device(s) 414 or the like may execute one or more application programming interface (APIs) (not shown in FIG. 3) that interface with any resident programs, such as instructions 420, 480 or the like stored in the memory 412 of the computing platform 410 and any external programs. Processing device(s) 414 may include various processing subsystems (not shown in FIG. 3) embodied in hardware, firmware, software, and combinations thereof, that enable the functionality of the computing platform 410 and the operability of the computing platform 410 on the distributed communications network 110 (shown in FIGS. 1 and 2). For example, processing subsystems allow for initiating and maintaining communications and exchanging data with other networked devices, such as data financial transaction database 200 and abandoned property compliance requirements database 300 (shown in FIGS. 1 and 2). For the disclosed aspects, processing subsystems of system 100 may include any processing subsystem used in conjunction with instructions 420 and 480 and related tools, routines, sub-routines, algorithms, sub-algorithms, sub-modules thereof. It should be noted that while computing platform 410 is shown and described as having separate instructions 420 and 480 the system may comprises more or less instructions (i.e., the functionality shown and described in relation to any one instructions may be combined into one comprehensive instructions or segregated into multiple different instructions and/or sub-instructions).

Computing platform 410 may additionally include a communications module (not shown in FIG. 3) embodied in hardware, firmware, software, and combinations thereof, that enables electronic communications between the computing platform 410 (e.g., eligible account activity identification servers 400 or the like) and other network devices, such as, but not limited to, financial transaction database 200 and abandoned property compliance requirements database 300 (shown in FIGS. 1 and 2). Thus, communication module may include the requisite hardware, firmware, software and/or combinations thereof for establishing and maintaining a network communication connection with one or more network devices.

Computing platform 120 includes first instructions 420 that are configured to receive electronic transaction data 422 associated with electronic transactions 424 from at least one, and in some embodiments all, of the plurality of financial accounts 220. The electronic transactions may include, but are not limited to, ACH transactions 424, wire transactions 426, automatic transfers 427, bill pay transactions 428, merchant payments 429 and the like. In specific embodiments of the invention the received electronic transaction data 422 reflects all of the electronic transactions that have occurred over a predetermined period of time (e.g., a week, a day or the like), while in other embodiments of the invention the determination of recurring versus one-time-only may occur on an individual transaction-by-transaction basis as electronic transaction data 422 is received. In specific embodiments of the invention, prior to the instructions 420 receiving the electronic transaction data 422 associated with electronic transactions 424 the overall corpus of financial transactions and accompany data may be paired down to only reflect the desired electronic financial transactions 424. As previously discussed, financial transactions are typically coded to indicate the type of transaction and, as such, in specific embodiments of the invention, the first instructions 420 may be configured to only receive financial transaction data that is coded to indicate an electronic transaction.

Further, the first instructions 420 are configured to access one or more of the financial transaction database(s) 200 to retrieve historical transaction data 210 associated with the at least one of the plurality of financial accounts 220.

Additionally, first instructions 420 are further configured to implement artificial intelligence, including machine-learning techniques 430, to identify recurring transaction patterns 432 in the historical transaction data 210. Machine learning provides for the recurring transaction patterns 432 to be identified over time and, therefore, the recurring transaction patterns may be identified during modeling/training modes of operation and/or during the current cycle and/or previous cycles of the identification of eligible account activity (e.g., recurring vs one-time-only). Recurring transaction patterns 432 are defined by one or more of (i) a same transacting party, (ii) a same financial account used to conduct the transactions, (iii) a same transaction code, (iv) similar or same transactions amount, and/or (iv) a same or similar periods of time between transactions.

In addition, the first instructions 420 are configured to implement artificial intelligence to analyze the recurring transaction patterns 432 and the electronic transaction data 422 to identify each of the electronic transactions 424 as either a one-time-only transaction 434 (i.e., non-recurring) or a recurring transaction 436 (i.e., a repetitive transaction between the same parties that occurs on a regular cycle (e.g., annually, bi-annually, monthly, bi-monthly, weekly, daily or the like)). In specific embodiments of the invention, identifying an electronic transaction as recurring may be based on one or more of (i) the electronic transaction using the same financial account as transactions in one of the recurring transaction patterns, (ii) the electronic transaction being assigned the same transaction code as the transactions within one of the recurring transaction patterns, (iii) the electronic transaction being conducted with the same transacting-party as the transactions in one of the recurring transaction patterns, (iv) the electronic transaction occurring within a predefined period of time from a last occurrence of a transaction within the recurring transaction pattern, and (v) the transaction being within a predefined variance of amount to other transactions within the recurring transaction pattern. In such embodiments of the invention, the predefined period of time from occurrence of the last transaction in the pattern and/or the predefined variance of amount may be defined based on the time cycle of the recurring transaction pattern (i.e., whether the transactions occur annually, bi-annually, monthly, bi-monthly, weekly, daily or the like).

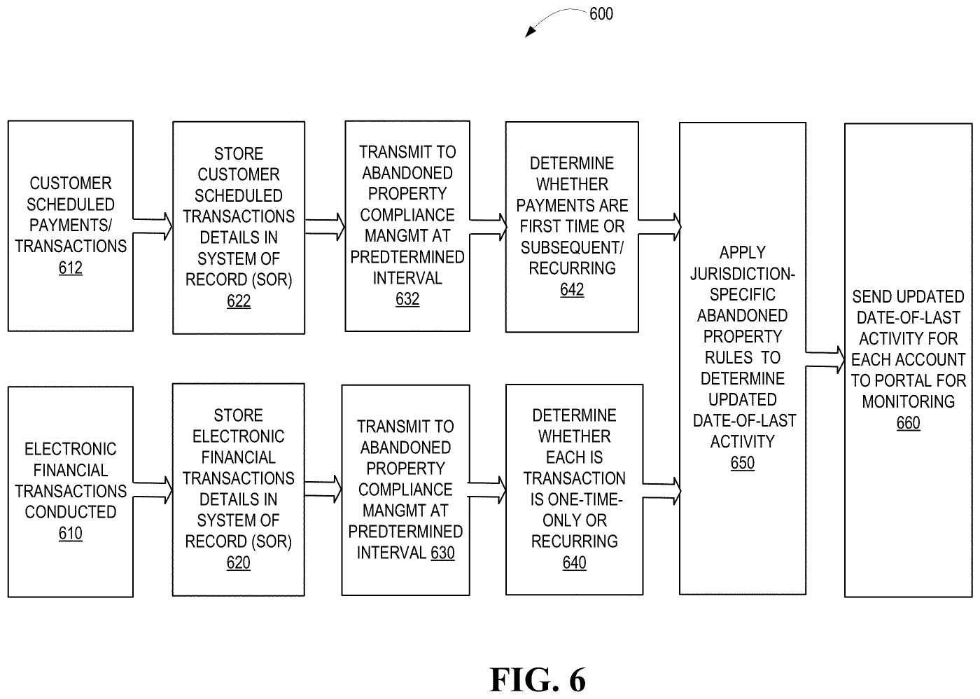

In accordance with specific embodiments of the invention, the first instructions 420 may be further configured to receive scheduled recurring transactions data 470 associated with customer/user-scheduled recurring transactions 472 (non-electronic or otherwise), such as, payment transactions scheduled by a customer/user within online or mobile banking. In accordance with specific embodiments of the invention, customer/user-scheduled recurring transactions 472 are transactions that are not subjected to the previously discussed recurring versus one-time-only determination. The instructions 420 are further configured to determine whether the transactions 472 are a first-time 474 occurrence of a transaction from the schedule or a subsequent occurrence of a transaction from the schedule, and, thus, deemed to be a recurring transaction 436. According to certain state-specific abandoned property compliance requirements, the first-time transaction from a schedule is considered a non-recurring transaction and is treated the same as a one-time only transaction for purpose of determining the date of last activity for a financial account. Further, discussion of such embodiments is described in relation to FIG. 6, infra.

The first instructions 420 are further configured to access the abandoned property compliance requirements database 300 to retrieve the location/state-specific abandoned property compliance requirements 310 associated with the jurisdiction 320 of the financial accounts(s) 220. Further, the first instructions 420 are configured to apply the abandoned property compliance requirements 310 to update a date of last activity 440 associated with each of the financial account(s) 220. As previously discussed, the abandoned property compliance requirements 310 indicate whether a specific location/state allows for recurring transactions and, in some instances, which type of recurring transactions, to count for purposes of a date of last activity. The update to the date of last activity 440 is based, at least in part, on the identification of each of the electronic transaction 424 as being either a one-time-only transaction 434 or a recurring transaction 436. For example, in those embodiments of the invention in which the first instructions 420 include determination of whether customer-scheduled recurring transactions 472 are a first time transaction 474 or a subsequent/recurring transaction 436, the results of these determinations, along with the results from the determinations of whether electronic transactions 424 are one-time only transactions 434 or recurring transactions 436, will be used to determine the update to the date of last activity 440 for financial accounts 220.

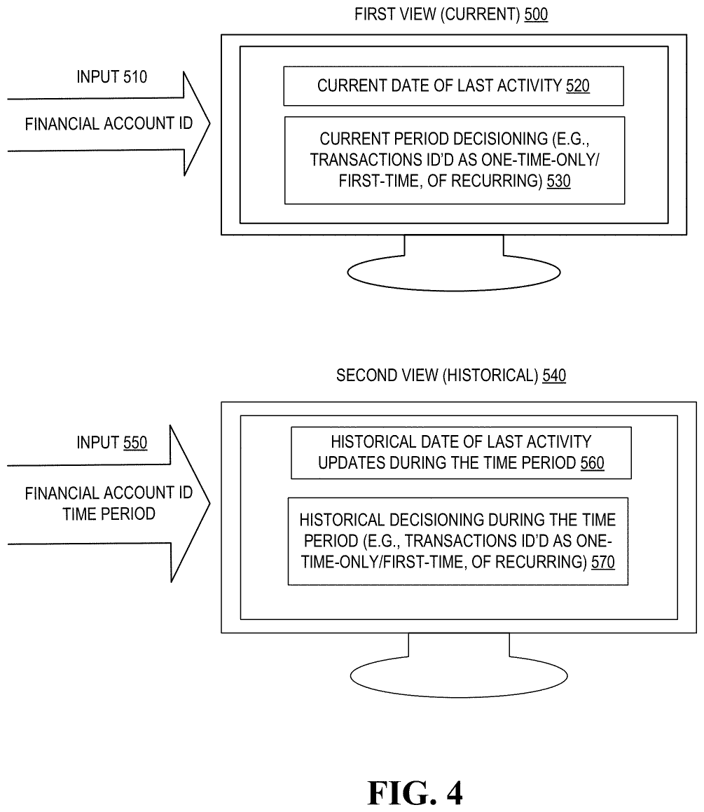

Moreover, first instructions 412 may provide for an abandoned property compliance portal/hub 460 that is configured to present a first view/user interface 500 and a second view/user interface 540, as shown in FIG. 4. The portal/hub 460 is configured to receive a user input 510 that identifies a financial account and, in response, is configured to display first view/user interface 500 that presents the current date of last activity 520 for the identified financial account. The current date of last activity 520 being the most recent update to the date of last activity. It should be noted that since other types of activities besides electronic transactions are considered for purposes of determining the date of last activity, the date of last activity for a financial account may reflect a date that is different than the date of the last recurring electronic transaction or last one-time-only electronic transaction. In addition, the first view/user interface 500 presents current period decisioning 530 (i.e., a listing of transactions considered for the most recent update to the date of last activity and, for each transaction, an indication of whether they were identified as one-time-only, first-time or recurring). In addition, the portal/hub 460 is configured to receive a user input 550 that identifies a financial account and a time period and, in response, is configured to display second view/user interface 540 that presents the historical data of the date of last activity updates 560 that occurred during the identified time period. In addition, the second view/user interface 540 presents historical decisioning 570 (i.e., listing of transactions decisioned during the identified time period and, for each transaction, an indication of whether they were identified as one-time-only, first-time or recurring).

Referring again to FIG. 3, the memory 412 of computing platform 420 additionally stores second instructions 470 that are configured to monitor the date of last activity 440, along with other relevant account-related dates/factors, to determine when escheatment occurs (i.e., when property in a financial reverts to the state due to inactivity for a prescribed period of time). In this regard, monitoring entails determining when a time period 482 between the date of last activity 440 and a current date 484 exceeds an abandoned property requirements time period 486 as defined by the location/state-specific abandoned property compliance requirements 310. The instructions 480 may be further configured to trigger automatic property reversion/escheatment 496 of the property held in the financial account 220 in response to the determination that the time period 482 between the date of last activity 422 and the current date 484 exceeds the abandoned property compliance requirements time period 486.

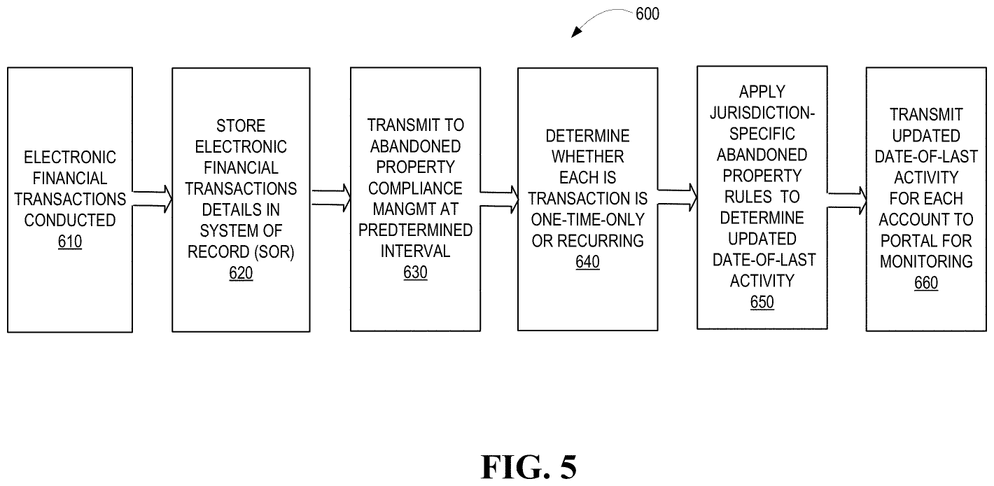

Referring to FIG. 5, a flow diagram is depicted of a method 600 for evaluating transaction data to determine activity that is eligible to update a date of last activity associated with a financial account, in accordance with embodiments of the present invention. At Event 610, electronic financial transactions are conducted by customers/users, for example, customers conduct ACH transactions, wire transactions, bill payment transactions, automatic transfers, merchant payments or the like. At Event 620, details associated with the electronic financial transactions are stored in associated systems of record (SOR). At Event 630, the data associated with the electronic financial transactions, such as transaction code (i.e., type), transacting-party, amount, date/time and the like is transmitted to the eligible account activity identification system at predetermined time intervals, such as daily or the like.

At Event 640, the artificial intelligence-based algorithm is executed to determine which of the electronic financial transactions are recurring financial transactions and which are one-time-only financial transactions (i.e., determined to not be a recurring financial transaction). At Event 650, state-specific (or other physical location-specific) abandoned property compliance requirements are applied to determine an update to the date of last activity for those financial accounts in which an electronic transaction occurred during the previous predetermined time interval. As previously discussed, certain states' abandoned property compliance requirements allow for recurring financial transactions to update a date of last activity, while in other states recurring financial transactions are prohibited from updating the date of last activity. It should also be noted that activity other than the electronic financial transactions are considered for purposes of defining the date of last activity and, as such, the date of the least recurring electronic financial transaction or the date of the last one-time only electronic financial transaction may or may not define the date of last activity. In response to updating the date of last activity for those financial accounts in which transactions occurred, at Event 660, the updated date of last activity is transmitted to an abandoned property compliance portal/hub for subsequent monitoring for determination of when escheatment occurs. In addition, as previously discussed the abandoned property compliance portal/hub provides for display of various views, such as a current view depicting, at least, the current date of last activity for a chosen financial account and related time interval decisioning for the electronic financial transactions that occurred during the most recent decisioning period. In addition, the portal/hub is configured to display an archived view that depicts, for a chosen time period, at least, the historical updates to the date of last activity that occurred during the time period and the related decisioning for the electronic financial transactions that occurred during the chosen time period.

Referring to FIG. 6, a flow diagram is depicted of an alternative method 600 for evaluating transaction data to determine activity that is eligible to update a date of last activity associated with a financial account, in accordance with embodiments of the present invention. The method 600 of FIG. 6 includes all of the Events shown and discussed in relation to FIG. 5. In addition, the method of FIG. 6 includes, at Event 612, customers/users scheduling the occurrence of recurring transactions/payments via online/mobile banking or the like. At Event 620, details associated with the customer/user scheduled recurring transactions/payments are stored in associated systems of record (SOR). At Event 632, the data associated with the scheduled recurring transactions is transmitted to the eligible account activity system at predetermined time intervals, such as daily or the like.

At Event 642, a determination is made as to whether the scheduled recurring transaction/payment is a first-time occurrence of the scheduled payment or a subsequent (i.e., later than the first) occurrence of the scheduled payment. For purposes of abandoned property compliance requirements, certain states treat first-time occurrences of a scheduled payment as a non-recurring financial transaction (i.e., only subsequent scheduled recurring transactions, after the first occurrence, are treated as recurring transactions). At Event 650, state-specific (or other physical location-specific) abandoned property compliance requirements are applied to determine an update to the date of last activity for those financial accounts in which an electronic transaction or a customer-scheduled recurring transaction/payment occurred during the previous predetermined time interval. In contrast to the method shown in FIG. 5, in the method of FIG. 6, the abandoned property compliance requirements are applied to both the results of the electronic transaction decisioning (i.e., one-time only vs recurring) and the customer-scheduled recurring transactions/payment decisioning (i.e., first occurrence of scheduled transaction vs subsequent occurrence of scheduled transaction/recurring) to determine an update to the date of last activity Similar to the embodiments of the invention discussed in relation to FIG. 5, activity other than the electronic financial transactions and the customer scheduled payments/transactions are considered for purposes of defining the date of last activity and, as such, the date of the last recurring electronic financial transaction or customer scheduled payment, the date of the last one-time only electronic financial transaction or the date of the last first time customer scheduled payment may or may not define the date of last activity.

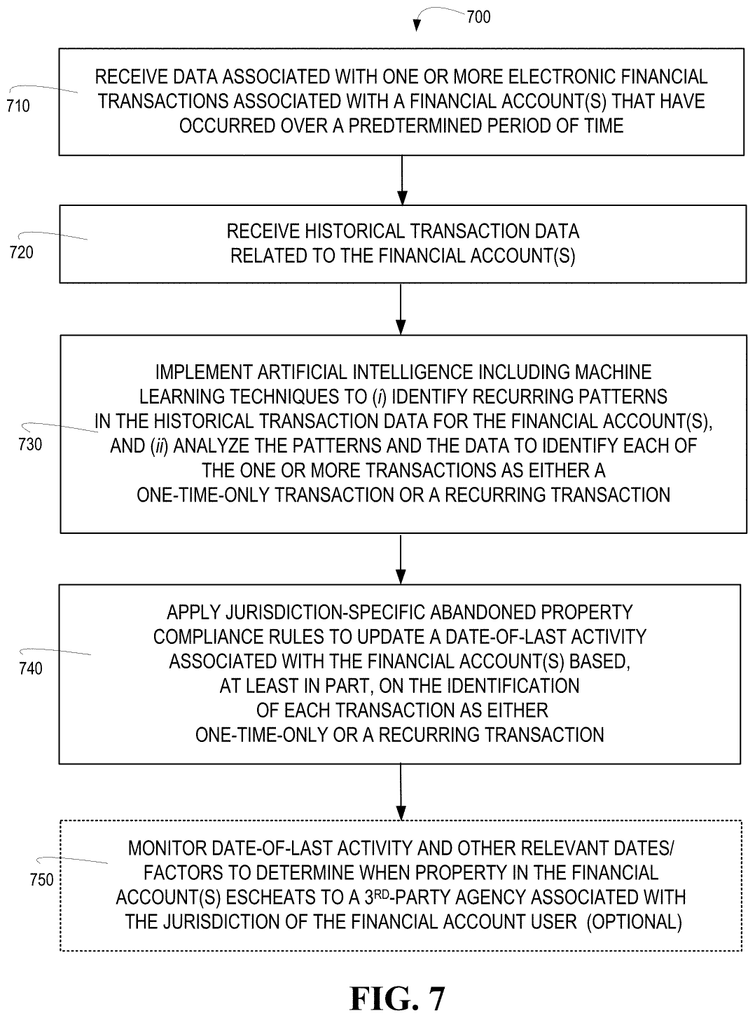

Referring to FIG. 7, a flow diagram is presented of a method 700 for evaluating transaction data to determine activity that is eligible to update a date of last activity associated with a financial account, in accordance with embodiments of the present invention. At Event 700, data associated with one or more electronic financial transactions from a financial account is received. In specific embodiments of the invention, the data is received for electronic financial transactions that occurred over a predetermined time period (e.g., previous day, previous week or the like). The electronic transactions received may be parsed from the corpus of financial transactions based on transaction coding or the like. The electronic transactions may include, but are not limited to, ACH transactions, wire transactions, bill payment transactions, automatic transfer transactions, recurring merchant payment transactions and the like.

At Event 710, the historical transaction data related to the financial accounts is received. In specific embodiments of the method, one or more financial transaction databases are accessed, and applicable historical transaction data associated with the financial accounts is retrieved.

At Event 720, artificial intelligence including machine learning techniques are used to identify, over time, recurring transaction patterns in the historical transaction data. Recurring transaction patterns are defined by one or more of (i) a same transacting party, (ii) a same financial account used to conduct the transactions, (iii) a same transaction code, (iv) a similar or same transactions amount, and/or (iv) a same or similar periods of time between transactions. Additionally, the recurring transaction patterns may be identified at any point in time, such as, but not limited to, when the AI algorithm is in a modeling or training mode or during any, including the current, transaction decisioning processes (i.e., determining when transactions are recurring or one-time only). Further, artificial intelligence is used to analyze the recurring transaction patterns and the data associated with the one or more electronic financial transactions to identify each of the electronic financial transactions as either a recurring transaction or a one-time-only transactions (i.e., not recurring). In specific embodiments of the method, identifying an electronic transaction as recurring may be based on one or more of (i) the electronic transaction using the same financial account as transactions in one of the recurring transaction patterns, (ii) the electronic transaction being assigned the same transaction code as the transactions within one of the recurring transaction patterns, (iii) the electronic transaction being with the same transacting-party as the transactions in one of the recurring transaction patterns, (iv) the electronic transaction occurring within a predefined period of time from a last occurrence of transaction within the recurring transaction pattern and (v) the electronic transaction being within a predefined variance of amount to other transactions within the recurring transaction pattern.

At Event 740, location-specific (i.e., U.S. state-specific or the like) abandoned property compliance requirements are applied to update a date of last activity. Specific states allow for recurring financial transactions (or specific types of recurring electronic transactions) to update a date of last activity, while other states prohibit recurring financial transactions from updating the date of last activity. The date of last activity is based, at least on the part, on the identification of each of the electronic transactions as being either one-time only or recurring. In this regard, the most recent recurring electronic transaction or the most recent one-time only electronic transaction defines the date of last activity absent data related to other recurring transactions (e.g., customer specified and/or merchant-specified) which may, in specific embodiments of the method, also be used in determining a date of last activity.

At optional Event 750, the date of last activity is monitored, along with other dates of interest (e.g., data of last contact) to determine when property remaining in an inactive financial account reverts/escheats to a third-party agency associated with the jurisdiction of the financial account (i.e., a state agency or the like). In this regard, the date of last activity defines the period of inactivity, which is compared to the state-specific time period for escheatment (e.g., five years or the like) to determine whether property remaining in an inactive financial is required to revert to the state.

Thus, present embodiments of the invention as described above provide for identifying eligible account activity including a related date of last activity for purposes of managing escheatment. Specifically, the present embodiments of the invention provide for implementing artificial intelligence including machine learning techniques to definitively identify, which electronic transactions are recurring transactions and subsequently apply state-specific abandoned property compliance requirements to determine a date of last activity for a financial account. In specific embodiments of the invention, the date of last activity, along with other dates of interest, are monitored to determine when property remaining in an inactive financial account escheats to the state.

The features, functions, and advantages that have been discussed may be achieved independently in various embodiments of the present invention or may be combined with yet other embodiments, further details of which can be seen with reference to the following description and drawings.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for evaluating transaction data to determine activity that is eligible to update a date of last activity associated with a financial account, the system comprising:
one or more financial transaction databases that store historical transaction data for financial accounts; and
a first computing platform including a first memory and at least one first processor in communication with the first memory, wherein the first memory stores first instructions that are executable by the first processor and configured to:
receive data associated with one or more electronic financial transactions associated with a financial account occurring over a predetermined period of time,
access the one or more financial transaction databases to retrieve the historical transaction data for the financial account, and
implement artificial intelligence including machine learning techniques to:
identify recurring transaction patterns in the historical transaction data for the financial accounts, and
analyze the recurring transaction patterns and the data to identify each of the one or more electronic financial transactions as either a one-time-only transaction or a recurring transaction, and
apply abandoned property compliance requirements, which are specific to a jurisdictional entity at which a financial account holder is located, to update a date of last activity associated with the financial account based at least in part on the identification of each of one or more electronic financial transactions as either a one-time-only transaction or a recurring transaction.

2. The system of claim 1, wherein the first instructions are further configured to:
provide for an abandoned property compliance portal configured to generate and display, in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction.

3. The system of claim 2, wherein the first instructions are further configured to:
provide for the abandoned property compliance portal configured to generate and display, in response to receiving a user input that identifies the financial account a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

4. The system of claim 1, further comprising:
a second computing platform including a second memory and at least one second processor in communication with the second memory, wherein the second memory stores second instructions that are executable by the second processor and configured to:
determine that a time period between the date of last activity or date of last contact and a current date exceeds an abandoned property time period defined in the abandoned property compliance requirements, and
in response to determining that the time period exceeds the abandoned property time period, escheat property in the financial account to a third-party agency associated with a jurisdiction of the financial account.

5. The system of claim 1, wherein the first instructions are further configured to:
receive indication of a scheduled transaction from a customer-configured recurring transaction schedule,
in response to determining that that the scheduled transaction is a first-time occurrence of the scheduled transaction, identify the scheduled transaction as a first-time transaction, and
in response to determining that that the scheduled transaction is not a first-time occurrence of a scheduled transaction from the customer-configured recurring transaction schedule, identify the scheduled transaction as a recurring transaction.

6. The system of claim 5, wherein the first instructions configured to apply the abandoned property compliance requirements to update the date of last activity associated with the financial account is based on identification of at least one of (i) each of the one or more electronic financial transactions as either a one-time-only transaction or a recurring transaction, and (ii) the scheduled transaction as the first-time transaction or a recurring transaction.

7. The system of claim 1, wherein the first instructions configured to analyze the recurring transaction patterns to identify each of the one or more electronic financial transactions are further configured to identify a transaction as recurring based on one or more of (i) the transaction using a same financial account as one of the recurring transaction patterns, (ii) the transaction being assigned a same transaction code as one of the recurring transaction patterns, (iii) the transaction being same transacting-party as one of the recurring transaction patterns, (iv) the transaction occurring within a predefined period of time from a last occurrence of another transaction within one of the recurring transaction patterns, and (iv) the transaction being within a predefined variance of a transaction amount of other transactions within one of the recurring transaction patterns.

8. The system of claim 7, wherein the first instructions configured to identify a transaction as recurring based on (iv) the transaction occurring within a predefined period of time from a last occurrence of another transaction within one of the recurring transaction patterns, and (iv) the transaction being within a predefined variance of a transaction amount of other transactions within one of the recurring transaction patterns, define at least one of the predefined period of time and the predefined variance based on a time cycle of the recurring transaction patterns.

9. The system of claim 1, wherein the first instructions configured to receive the data associated with the one or more electronic financial transactions are further configured to receive the data associated with the one or more electronic financial transactions, wherein the electronic financial transactions are defined as at least one of (i) Automated Clearing House (ACH) transactions, and (ii) wire transactions, (iii) electronic bill pay, (iv) automatic transfers, and (v) merchant payments.

10. The system of claim 1, wherein the abandoned property compliance requirements are configured for either (i) a most recent occurrence of a one-time-only transaction, or (ii) a most recent occurrence of a recurring transaction defining the date of last activity associated with the financial account.

11. The system of claim 10, wherein the abandoned property compliance requirements are further configured for a type of a recurring transaction to define the date of last activity associated with the financial account.

12. A computer-implemented method for evaluating transaction data to determine activity that is eligible to update a date of last activity associated with a financial account, the method is executed by one or more computing processor devices and comprises:
receiving data associated with one or more electronic financial transactions associated with a financial account occurring over a predetermined period of time;
receiving historical transaction data related to the financial account;
implementing artificial intelligence including machine learning techniques for:
identifying recurring transaction patterns in the historical transaction data for the financial account; and
analyzing the recurring transaction patterns and the data to identify each of the one or more electronic financial transactions as either a one-time-only transaction or a recurring transaction; and
applying abandoned property compliance requirements, which are specific to a jurisdictional entity at which a financial account holder is located, to update a date of last activity associated with the financial account based at least in part on the identification of each of one or more electronic financial transactions as either a one-time-only transaction or a recurring transaction.

13. The computer-implemented method of claim 12, further comprising:
generating and displaying, within an abandoned property portal:
in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction, and
in response to receiving a user input that identifies the financial account a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

14. The computer-implemented method of claim 12, further comprising:
determining that a time period between the date of last activity or a date of last contact and a current date exceeds an abandoned property time period defined in the abandoned property compliance requirements; and
in response to determining that the time period exceeds the abandoned property time period, escheat property in the financial account to a third-party agency associated with a jurisdiction of the financial account.

15. The computer-implemented method of claim 12, further comprising:
receiving indication of a scheduled transaction from a customer-configured recurring transaction schedule;
in response to determining that that the scheduled transaction is a first-time occurrence of the scheduled transaction, identifying the scheduled transaction as a first-time transaction;
in response to determining that that the scheduled transaction is not a first-time occurrence of a scheduled transaction from the customer-configured recurring transaction schedule, identifying the scheduled transaction as a recurring transaction; and
wherein applying the abandoned property compliance requirements further comprises:
applying the abandoned property compliance requirements to update the date of last activity associated with the financial account is based on identification of at least one of (i) each of the one or more electronic financial transactions as either a one-time-only transaction or a recurring transaction, and (ii) the scheduled transaction as the first-time transaction or a recurring transaction.

16. The computer-implemented method of claim 12, wherein analyzing the recurring transaction patterns further comprises analyzing the recurring transaction patterns to identify each of the one or more electronic financial transactions as the recurring transaction based on one or more of (i) the transaction using a same financial account as one of the recurring transaction patterns, (ii) the transaction being assigned a same transaction code as one of the recurring transaction patterns, (iii) the transaction being same transacting-party as one of the recurring transaction patterns, (iv) the transaction occurring within a predefined period of time from a last occurrence of another transaction within one of the recurring transaction patterns, and (iv) the transaction being within a predefined variance of a transaction amount of other transactions within one of the recurring transaction patterns.

17. A computer program product comprising:
a non-transitory computer-readable medium comprising:
a first set of codes for causing a computer to receive data associated with or more electronic financial transactions associated with a financial account occurring over a predetermined period of time;
a second set of codes for causing a computer to receive historical transaction data related to the financial account; and
a third set of codes for causing a computer to implement artificial intelligence including machine learning techniques to (i) identify recurring transaction patterns in the historical transaction data for the financial accounts, (ii) analyze the recurring transaction patterns and the data to identify each of the one or more electronic financial transactions as either a one-time-only transaction or a recurring transaction, and
a fourth set of codes for causing a computer to apply abandoned property compliance requirements, which are specific to a jurisdictional entity at which a financial account holder is located, to update a date of last activity associated with the financial account based at least in part on the identification of each of one or more electronic financial transactions as either a one-time-only transaction or a recurring transaction.

18. The computer program product of claim 17, wherein the non-transitory computer-readable medium further comprises:
a fifth set of codes for causing a computer to generate and display, within an abandoned property portal:
in response to receiving a user input that identifies the financial account, a first view that indicates at least (i) a current date of last activity for the financial account, and (ii) identification of each as the one or more transactions, used in determining the current date of last activity, as either a one-time-only transaction or a recurring transaction, and
in response to receiving a user input that identifies the financial account a time period, a second view that indicates at least (i) historical updates to the date of last activity occurring during the time period, and (ii) historical identification of each as the one or more transactions, used in determining the updates to the date of last activity, as either a one-time-only transaction or a recurring transaction.

19. The computer program product of claim 17, wherein the non-transitory computer-readable medium further comprises:
a fifth set of codes for causing a computer to determine that a time period between the date of last activity or a date of last contact and a current date exceeds an abandoned property time period defined in the abandoned property compliance requirements, and, in response to determining that the time period exceeds the abandoned property time period, escheat property in the financial account to a third-party agency associated with a jurisdiction of the financial account.

20. The computer program product of claim 17, wherein the non-transitory computer-readable medium further comprises:
a fifth set of codes for causing a computer to receive indication of a scheduled transaction from a customer-configured recurring transaction schedule, in response to determining that that the scheduled transaction is a first-time occurrence of the scheduled transaction, identifying the scheduled transaction as a first-time transaction, and, in response to determining that that the scheduled transaction is not a first-time occurrence of a scheduled transaction from the customer-configured recurring transaction schedule, identifying the scheduled transaction as a recurring transaction, and
wherein the fourth set of codes is further configured to cause the computer to apply the abandoned property compliance requirements to update the date of last activity associated with the financial account is based on identification of at least one of (i) each of the one or more electronic financial transactions as either a one-time-only transaction or a recurring transaction, and (ii) the scheduled transaction as the first-time transaction or a recurring transaction.
